(19) United States
(12) Patent Application Publication
(10) Pub. No.: US 2024/0126565 A1
(43) Pub. Date: Apr. 18, 2024

(54) OFFLINE PROCESSING OF WORKLOADS STORED IN REGISTRIES

(71) Applicants: Akhilesh Thyagaturu, Tampa, FL (US); Scott M. Baker, Eugene, TX (US); Jonathan L. Kyle, Atlanta, GA (US); Vaghesh Patel, Frisco, TX (US); Adib Rastegarnia, Sunnyvale, CA (US)

(72) Inventors: Akhilesh Thyagaturu, Tampa, FL (US); Scott M. Baker, Eugene, TX (US); Jonathan L. Kyle, Atlanta, GA (US); Vaghesh Patel, Frisco, TX (US); Adib Rastegarnia, Sunnyvale, CA (US)

(21) Appl. No.: 18/396,364

(22) Filed: Dec. 26, 2023

(51) Int. Cl. G06F 9/445; G06F 11/30

(52) U.S. Cl. CPC G06F 9/44505; G06F 11/302; G06F 11/3058

(57) ABSTRACT

Embodiments of offline profiling of applications are disclosed herein. In one example, a plurality of applications are received from an application registry, and the applications are profiled in an offline environment to determine the behavior of the applications during execution. Based on the behavior of the applications, an application package for performing a particular function is generated. The application package includes a configuration of a set of applications for performing the particular function, where the set of applications are identified from the applications that were profiled. The generated application package is then stored in the application registry.

### BACKGROUND

An application registry is typically used to store information about software applications and associated resources. For example, a registry may be used to store a collection of applications that can potentially be deployed in a distributed computing environment. The applications in the registry are generally not in use until a registry pull or push request is received. Moreover, multiple applications often need to be deployed together in a cooperative manner This is typically a manual process that involves retrieving the appropriate applications from the registry, configuring the applications for the particular use case, and then deploying the applications in the distributed computing environment using the appropriate configuration.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures.

FIG. 1 illustrates a system for profiling applications stored in a registry.

FIG. 2 illustrates a system for offline application profiling and catalog creation.

FIG. 3 illustrates a system for application recommendations based on user queries.

FIG. 4 illustrates a process for profiling applications and generating catalog recommendations.

FIG. 5 illustrates an example of generating a new application catalog using workload characterization.

FIG. 6 illustrates a flowchart for generating application packages based on offline workload profiling.

FIG. 7 illustrates an example of a compute node.

FIG. 8 illustrates an example of an infrastructure processing unit.

FIG. 9 illustrates an example of an edge cloud environment.

FIG. 10 illustrates an example of operational layers in an edge cloud environment.

### EMBODIMENTS OF THE DISCLOSURE

An application registry typically refers to a repository (or collection of repositories) for storing information about software applications and associated resources. In particular, an application registry may provide a standardized and organized framework for managing, storing, and/or retrieving information associated with software applications, such as application images (e.g., container images), executables, software libraries and application programming interfaces (APIs), metadata, configuration information, dependencies, security information, and so forth.

In some cases, for example, a registry may be used to store a large volume of applications that can potentially be deployed in an edge or cloud computing environment. The applications are typically stored in the registry in stored-offline format, as they are generally not in use until a registry pull or push request is received.

Moreover, multiple applications often need to be deployed together in a cooperative manner to form an overall solution. This is typically a manual process that involves retrieving the appropriate applications from the registry, configuring the applications for the particular use case, testing/profiling the applications, and then deploying the applications on the edge and/or cloud infrastructure using the appropriate configuration. This manual process for configuring and deploying applications can be tedious, inefficient, and time consuming and may increase costs.

Accordingly, this disclosure presents embodiments of offline workload processing for automated application configuration and deployment. For example, the described solution leverages offline profiling of workloads (e.g., applications stored in registries) to automatically recommend, configure, and/or deploy the appropriate combination of applications for a given use case, as described further throughout this disclosure.

The described solution potentially provides various advantages, including, without limitation, more efficient management and configuration of applications, improved performance, and cost savings. For example, edge and cloud technologies use registries and repositories to store a large scale of applications, and it can be challenging to manage and deploy these applications with configurations that perform well in every deployment scenario. However, with additional information characterized for the applications on the respective compute/hardware platforms in the infrastructure, the orchestration system can quickly adapt to the deployment needs of the applications and users.

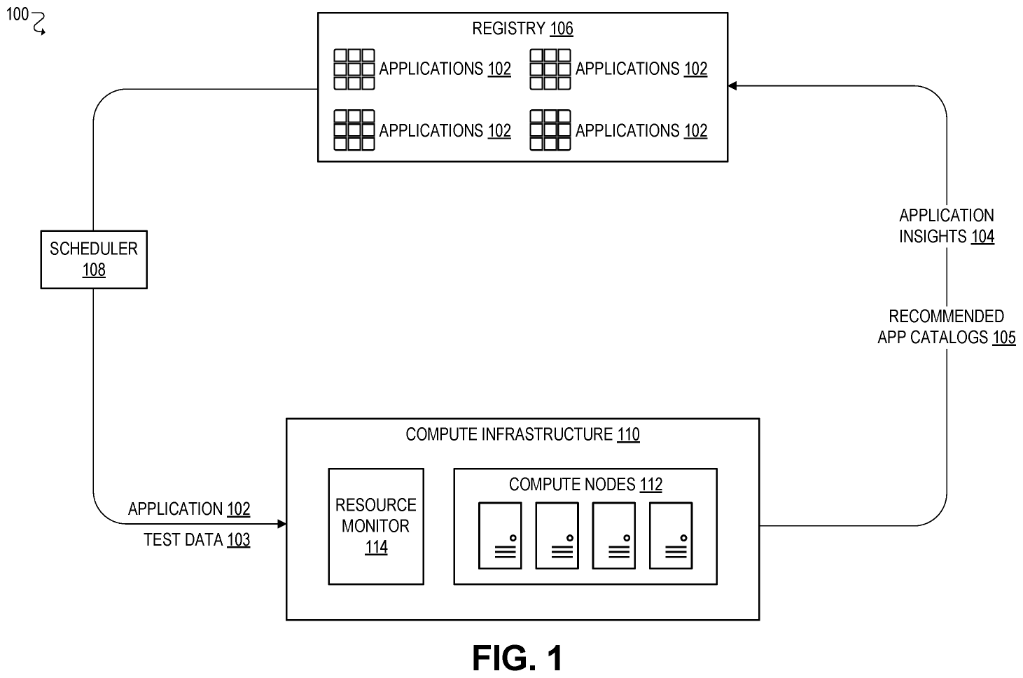

FIG. 1 illustrates an example of a system 100 for profiling applications 102 stored in a registry 106. For example, applications 102 stored in the registry 106 may be opportunistically profiled on idle or underutilized compute nodes 112 in a compute infrastructure 110 (e.g., a cloud computing infrastructure or data center) to provide application insights and recommendations 104, as described further below.

In the illustrated embodiment, the applications 102 stored in the registry 106 are scheduled for offline profiling on the compute infrastructure 110 by a scheduler 108. In some embodiments, the scheduler 108 may opportunistically schedule the applications 102 for offline profiling on compute nodes 112 that are idle or underutilized. For example, in a distributed large-scale compute infrastructure (e.g., cloud or edge), certain nodes 112 may be idle or underutilized at any given time, meaning those nodes 112 are active but no workloads are currently scheduled on them, or they are not being fully utilized by the workloads that are currently scheduled on them. As a result, these idle or underutilized nodes 112 have available processing/resource capacities for profiling applications 102 stored in the registry 106. In this manner, idle cycles of the compute nodes 112 (e.g., cloud/data center nodes and edge nodes with significant compute capabilities) are used to profile applications 102 that would otherwise be sitting idle in storage within the registry 106.

In some embodiments, for example, the applications 102 stored in the registry 106 may be profiled offline (e.g., executed on compute nodes 112 in a secure testing environment using test data 103) to learn about the runtime behavior of the applications 102 and the respective compute platforms 112 on which they are profiled. For example, a resource monitor 114 may be used to monitor application behavior and compute platform characteristics during execution of an application 102 on different types of compute hardware and under different configurations. The workload profiling may be used to evaluate various behavioral aspects of the applications 102 and the different compute platforms, including, without limitation, performance/cost (e.g., compute, power, thermal, etc.), user experience, scheduling and policy estimation, network behavior and requirements, security, and so forth. This profiling information may enable various optimizations to the applications 102, along with automated creation of application packages and catalogs 105 for providing different types of functionality.

Workload profiling typically involves gathering data about a workload (e.g., an application) running on a system to gain insights into its behavior, including, without limitation, resource utilization, performance metrics, concurrency/parallelism, input/output (I/O) patterns, temporal characteristics, application-specific metrics, etc. For example, resource utilization may be monitored to determine how the workload utilizes different system resources (e.g., CPU, memory, disk, and network), which can help identify potential bottlenecks and optimize resource allocation. Performance metrics (e.g., key performance indicators (KPIs)) may be monitored/measured to assess the performance of the workload (e.g., response time, throughput, and latency). The degree of concurrency/parallelism of the workload may be evaluated to identify potential performance optimizations through features such as parallel processing or multithreading. I/O patterns may be analyzed to determine the behavior of the workload and optimize data storage and access strategies. Temporal characteristics may be analyzed to determine how the workload varies over time (e.g., peak utilization vs. idle/low utilization), which may help optimize tasks such as capacity planning and resource allocation. Various other application-specific metrics may also be collected for a given application (e.g., the number/rate of requests or user sessions handled by the application, response times, etc.). In this manner, workload profiling enables performance and resource utilization optimizations for a workload running on a particular compute platform, as the insights into behavior of the workload and the compute platform enable informed decisions regarding workload/system configuration, resource allocation, performance tuning, etc.

In some embodiments, for example, the application images 102 are profiled offline to generate metadata for orchestration that can be used for performance estimation and optimization (e.g., compute, power, thermal, security optimization), lifecycle management (e.g., migration and scaling), learning-based catalog creation (e.g., publishing/distribution), and application recommendations (e.g., service management/chaining recommendations).

Further, the registry 106 includes static metadata that describes the composite nature of the respective applications 102, which may be used as the basis for a catalog entry in the registry 106 for each composite application 102. This static metadata can be combined with the profiling information 104 to form a specific catalog entry and the basis for a deployment plan for a composite application 102. Further, suggested application catalogs 105 can be recommended based on offline processing of the application images 102 in the registry 106.

For example, multiple applications 102 often need to be deployed together in a cooperative manner to form an overall solution (e.g., an end-to-end service for video streaming, video processing pipeline, private 5G wireless network, intrusion detection system, etc.). Metadata may be used to describe how these applications 102 are linked together to form a composite application 102. This metadata is stored in the registry 106 and may be used as input to create application catalog entries 105 based on offline workload profiling. For example, multiple applications or services 102 may need to be chained together to provide certain functionality. Based on offline processing of the applications 102 (e.g., using profiling and/or machine learning techniques), an application catalog or package 105 may be created, which may include multiple applications/services 102 chained together and configured to cooperatively provide the requested functionality.

Security and permission metadata may also be stored in the registry 106 to specify which customers the respective applications 102 should be published to. For example, the publishing scheme may allow a single publisher to publish applications 102 to the catalogs of multiple customers, doing so in a secure manner with the consent of both the publisher and the customers.

In this disclosure, a workload may refer to any type and/or amount of work to be performed by one or more computing devices or resources. In some embodiments, a workload may include one or more tasks and/or various dependencies among those tasks, where each task includes a discrete function, assignment, or unit of work associated with the workload. In this disclosure, the terms “workload,” “application,” and “service” may be used interchangeably to refer to one or more workloads or workload tasks implemented by software. In various embodiments, a workload and its tasks may be embodied as a collection of software, including code, software libraries, applications, microservices, operating systems, virtual machines, containers, and so forth. For example, in some embodiments, a workload, application, or service may include a set of tasks that are respectively implemented by software packaged in one or more container or virtual machines images. Further, the respective tasks may be orchestrated for execution on the same or different compute devices and/or hardware resources.

In this disclosure, the terms “registry” and “repository” may be used interchangeably to refer to any mechanism for storing information associated with software (e.g., applications). In some cases, a repository may include a collection of software images, and a registry may include a collection of repositories.

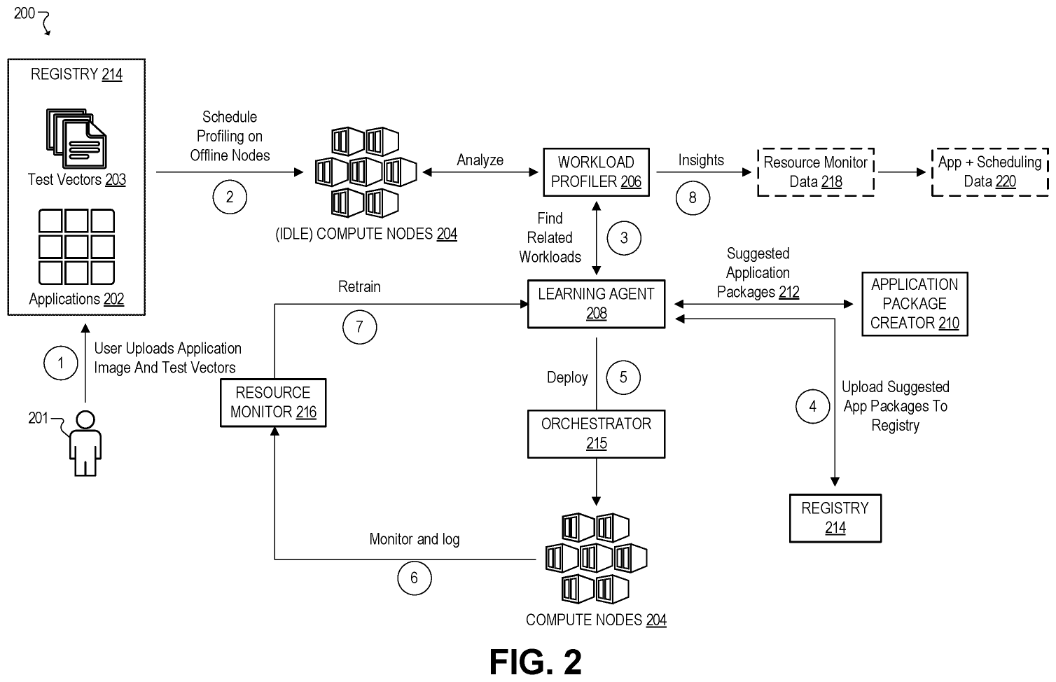

FIG. 2 illustrates an example implementation of a system 200 for offline application profiling and catalog creation. For example, applications 202 may be opportunistically profiled on idle or underutilized compute nodes 204 to learn about their behavior, optimize performance, and create application packages 212 (e.g., catalogs of applications 202) that implement a wide variety of functionality (e.g., end-to-end services), as described further below.

In the illustrated embodiment, a user 201 uploads an application 202 and associated test vectors 203 to the registry 214. The application 202 may be in the form of an application image that contains executable application files along with other associated resources (e.g., application metadata, configuration/deployment information, dependencies, security information). The test vectors 203 may contain sample data that can be used as input to test/profile the application 202 (e.g., logs, files, media).

The application 202 may be an individual application or a composite application that includes a set of applications.

In general, each application may include a description of how the application is deployed, versioning information, a set of application profiles, a namespace, application programming interface (API) and/or graphical user interface (GUI) extension, a set of profiling metrics, and/or a list of tunable parameters. The description of how the application is deployed may be in the form of a Helm chart, and the name/version of the Helm chart may be linked to the application repository. The versioning information may be used to authoritatively differentiate between different versions of the same application. The application profiles may include specific configuration settings that may be used when deploying the application in different scenarios. For example, different profiles may be used to configure the application for specific purposes, to match specific hardware, or to adjust the resource utilization and performance of the application. The namespace may identify a logical domain in which the application is to be deployed (e.g., a Kubernetes namespace), which may enable the application to cooperate with applications in the same namespace while being kept separate from applications in other namespaces. The API and/or GUI extension may be a description of how the application API or graphical user interface may be aggregated into a northbound API or northbound GUI for manageability from a single point. The set of profiling metrics may include various metrics that are to be collected and analyzed when the application is profiled. The list of tunable parameters may include adjustable configuration settings/parameters for the application, which may be automatically adjusted/tuned based on inference from the profiling tools.

A composite application may include a set of one or more applications. Accordingly, a composite application may include the information identified above for each application in the set, along with additional information specific to the composite application, such as versioning information, one or more composite profiles, an access grant, other human-readable data, etc. The versioning information may be used to authoritatively differentiate between different versions of the same composite application. The composite profiles may provide a means of linking each application profile for the respective applications in the composite application, such that a set of application profiles may be selected as a group to form an overall solution. The access grant may identify the customers who are allowed to utilize the composite application. The human readable data may include descriptive text, images, etc., which may be used when generating a human-readable catalog entry for the composite application. The profiling metrics, tunable parameters, and API/GUI extensions for a composite application are the sum of those provided by the underlying applications in the composite application.

The application 202 may be checked into a version control repository, such as a git repository or any other suitable repository. The version control repository may provide access controls so that only authorized users can modify the composite application specification. The version control repository may also include a full change history of the composite application, which may be used to determine the audit history of the composite application and provide rollback and history of earlier versions of the composite application. Further, a linkage may be established between the version control repository and the orchestration system 215, such that the orchestration system 215 is informed of changes to the application. Finally, a catalog entry for the application may be constructed and made available to users.

The metadata generated by the learning module/agent 208 may be stored as associated data with the application 202, which the orchestrator 215 can use to directly associate the application 202 with its runtime characteristics.

The learning agent 208 may be part of the registry 214 or a separate function, where the function tries to estimate the overall processing time of applications 202 stored in the registry 214. The accuracy of the profile estimation and workload characterization is determined by the test vector input 203 provided by the user 201, which may be uploaded along with the application image 202.

The workload profiler 206 (e.g., workload monitor/application analyzer) identifies the requirements for compute, power, thermal, and other characterizations through application processing, and also captures information needed to estimate the service policy to schedule the application on a host (e.g., instantiation time, bring-up time, migration time).

The registry manager 214 may request the orchestrator 215 (e.g., a cloud orchestrator) to find idle or underutilized resources/nodes 204 to schedule the applications 202 in the registry 214 for offline characterization. During internal scheduling, applications 202 are instantiated in a sandbox that provides a secure execution environment. Internal scheduling may also handle horizontal and vertical scaling of workloads, along with the migration scenarios relative to the hardware utilization.

The learning agent 208 may include a learning module trained to identify inter-application relationships. For example, the learning module may implement a set of predictive models (e.g., neural network-based predictors) to observe patterns that correlate the applications 202 to form interrelations that can be offered as a service chain for an end-to-end user offering.

The learning agent 208 models may be trained using any suitable type and/or combination of artificial intelligence, machine learning, and/or data analysis techniques, including, without limitation, artificial neural networks (ANN), deep learning, deep neural networks, convolutional neural networks (CNN) (e.g., Inception/ResNet CNN architectures, fuzzy CNNs (F-CNN)), feed-forward artificial neural networks, multilayer perceptron (MLP), pattern recognition, scale-invariant feature transforms (SIFT), principal component analysis (PCA), discrete cosine transforms (DCT), recurrent neural networks (RNN), long short-term memory (LSTM) networks, transformers, clustering (e.g., k-nearest neighbors (kNN), Gaussian mixture models (gMM), k-means clustering, density-based spatial clustering of applications with noise (DBSCAN)), support vector machines (SVM), decision tree learning (e.g., random forests, classification and regression trees (CART)), gradient boosting (e.g., gradient tree boosting, extreme gradient boosted trees), logistic regression, Bayesian networks, Naïve-Bayes, moving average models, autoregressive moving average (ARMA) models, autoregressive integrated moving average (ARIMA) models, exponential smoothing models, regression analysis models, and/or ensembles thereof (e.g., models that combine the predictions of multiple machine learning models to improve prediction accuracy), among other examples.

The learning agent 208 may also leverage reinforcement learning techniques to retrain the model and improve its performance (e.g., inference accuracy) based on feedback during operation. For example, various system-collected data may be used for an offline approach to reinforcement learning, such source ID, time of day, types of tasks, priorities, dependencies between tasks, energy consumption, user feedback (e.g., user modifications to recommended application packages 212), etc. The training may be conducted using the collected data in a separate process to ensure that the reinforcement learning agent does not make mistakes while learning. The learning agent 208 may use the trained model to make decisions while deploying applications 202, and the agent 208 may receive penalties as feedback based on its actions, which helps to adjust its behavior over time to maximize its cumulative reward.

In some embodiments, the offline reinforcement learning algorithm may be developed by collecting a dataset from a previously trained agent or random policies, training the model with a reinforcement learning algorithm (e.g., Q-learning) using the collected training dataset, validating the performance of the model using offline data, and testing the model in a real-world environment and collecting data to periodically retrain the model.

In this manner, the learning agent 208 can recommend new application packages/catalogs 212 for providing different types of functionality, and those application packages/catalogs 212 can be automatically created by an application package creator 210. For example, a user may request a catalog of applications that can be deployed to provide a particular end-to-end service (e.g., a service association of applications, such as app 1→network→app 2). In some embodiments, natural language processing may be used to convert a text input describing an end-to-end solution (e.g., provided by a user) into a recommendation of the required application images 202 in the registry 214 for providing the described solution. Further, in some cases, the recommendation may be generated in the cloud but may be used or deployed in other environments, such as the edge. As an example, if a user queries the registry 214 for “private 5G networks,” then the registry manager 214 may recommend a set of services/applications 202 that need to be chained to implement a private 5G network, along with the physical nodes in the edge that the workload(s) need to be instantiated on (e.g., for an edge computing use case).

Thus, in an example end-to-end operation of the described system 200, a publisher/user 201 identifies a set of applications that collectively form a particular composite application 202. This often requires application-specific knowledge by the publisher, which is typically a software development and/or systems architecture task. A specification for the composite application 202 is created, listing the helm charts, profiles, versions, metrics, tunable parameters, and other constituent parts of the composite application as described above. The specification is checked into the version control repository. It may be either an entirely new composite application 202 present in that repository, or it may replace an earlier version. The orchestration tool 215 is notified of the change to the composite application 202, pulls the composite application specification from the version control repository, and updates the catalog. In some cases, there may be many orchestration tools 215 connected to a single version control repository, as the publishing mechanism may allow a one-to-many relationship. The learning module 208 may be trained previously as described above. Further, workload profiling (e.g., metric observation) may be opportunistically performed on idle or underutilized compute nodes 204. A resource monitor 216 may monitor resource utilization and other characteristics, and the resource monitor data 218 may be used to generate application/scheduling data 220. The learning module 208 may determine that a change should be made to the application 202 (e.g., a performance optimization). As a result, the tunable parameters may be updated, and the changes may be pushed to the orchestration tool, which then pushes the changes to the application deployments.

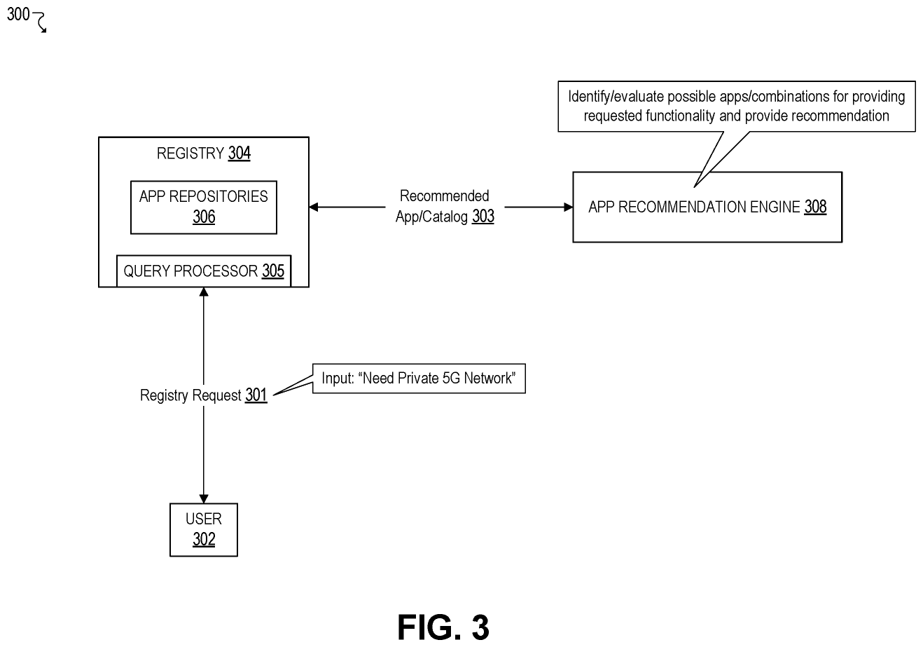

FIG. 3 illustrates an example of a system 300 for recommending applications based on user queries. In the illustrated embodiment, users 302 query the registry 304 for applications that provide certain requested functionality, and the app recommendation engine 308 recommends applications 303 that are capable of providing the requested functionality, as described further below.

In the illustrated example, a user 302 submits a request or query 301 to the registry 304 for an application that provides certain functionality requested by the user 302. In some embodiments, the requested functionality may be specified in natural language format (e.g., human language), such as “need private 5G network” or “provide intrusion detection system.”

The registry 304 receives the request 301 and uses a query processor 305 to process/parse the request 301. For example, if the requested functionality is specified in natural language format, the query processor 305 may interpret the request 301 using natural language processing (NLP) techniques (e.g., to convert the request 301 into a machine-readable format or language).

The registry 304 then forwards the interpreted request 301 to the app recommendation engine 308, which identifies and evaluates possible applications, combinations of applications, and/or configurations thereof for providing the requested functionality (e.g., using the learning/recommendation functionality described above with respect to systems 100, 200).

Based on the evaluation, the app recommendation engine 308 generates a recommendation 303 for providing the requested functionality, such as an individual application 303 or an application catalog 303 (e.g., application package). In some cases, for example, an individual application 303 may be capable of providing the requested functionality. In other cases, however, multiple applications or services may need to be chained together to provide the requested functionality. Thus, the app recommendation engine 308 may generate an application catalog/package 303 with multiple applications/services chained together and configured to cooperatively provide the requested functionality.

The app recommendation engine 308 provides the recommendation 303 to the registry 304, which optionally stores any new application catalogs 308 in an application repository 306 (e.g., for future queries) and then provides the recommendation 303 to the user 302.

The user 302 may then choose to deploy the recommended application/catalog 303, or the user 302 may optionally modify the recommended application/catalog 303 before deployment (e.g., by adding, removing, replacing, and/or reconfiguring certain applications and services in the application catalog 303). In the latter scenario, any modifications or feedback from the user 302 may be used by the app recommendation engine 308 to provide better recommendations in the future (e.g., using reinforcement learning techniques).

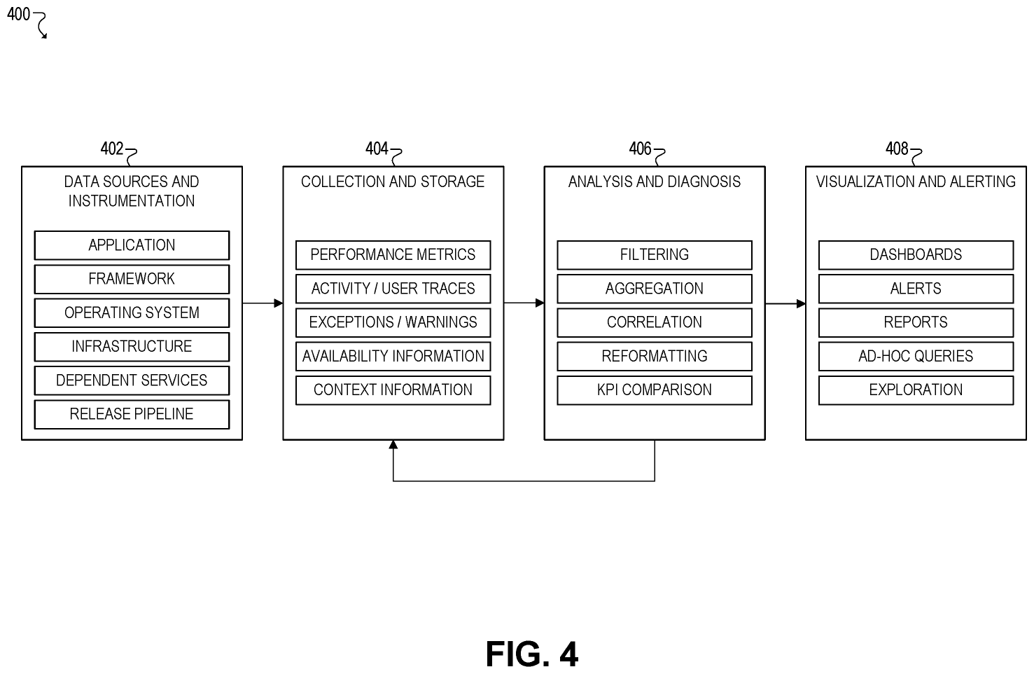

FIG. 4 illustrates an example of a process 400 for profiling applications and generating catalog recommendations for the orchestration framework. For example, based on the generated recommendations, the orchestration framework may deploy one or more of the recommended application catalogs onto a distributed computing infrastructure (e.g., an edge or cloud infrastructure).

In the first stage 402 of the process, information is collected regarding various data sources and instrumentation, including, without limitation, an application, its framework, operating system, computing infrastructure (e.g., on which the application may be deployed), dependent services, release pipeline, etc.

In the next stage 404 of the process, data is collected and stored regarding the behavior of the application during execution (e.g., based on profiling the application, among other sources), including, without limitation, performance metrics, activity/user traces, exceptions/warnings, availability information, context information, etc.

In the next stage 406 of the process, the data collected at stage 404 is analyzed and diagnosed to evaluate the behavior and performance of the application, reconfigure the application to improve performance and/or tailor its behavior, correlate the application with other related applications that may potentially be deployed in a cooperative manner (e.g., to provide certain functionality for a given use case), and so forth. The analysis and diagnosis stage may include tasks such as data filtering, aggregation, correlation, reformatting, comparison of key performance indicators (KPIs), etc.

In the final stage 408 of the process, the results of the analysis and diagnosis stage 406 are processed and/or presented using visualization and alerting techniques, including, without limitation, dashboards, alerts, reports, ad-hoc queries and responses, exploration, etc.

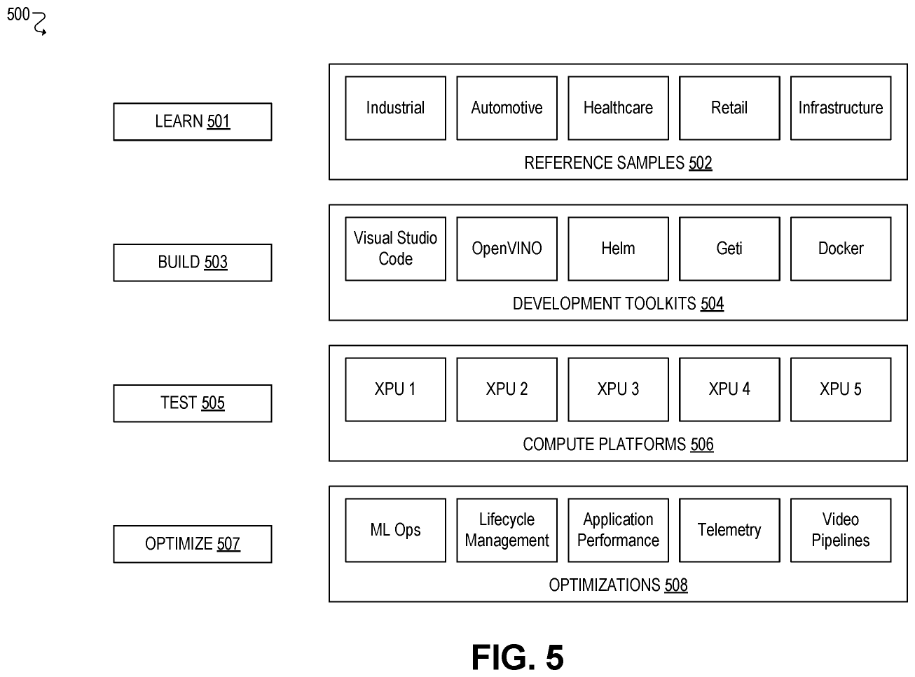

FIG. 5 illustrates an example 500 of generating a new application catalog using workload characterization. The illustrated example includes learn 501, build 503, test 505, and optimize 507 phases, as described further below.

In the learn phase 501, reference samples 502 are analyzed for a variety of applications and use cases (e.g., industrial, automotive, healthcare, retail, infrastructure).

In the build phase 503, applications are built (e.g., configured, compiled) for various deployment environments (e.g., different types of compute hardware) using the appropriate software development toolkits 504 (e.g., edge/cloud toolkits), such as source code editors/compilers (e.g., Visual Studio Code), artificial intelligence and machine learning (AI/ML) toolkits and software libraries (e.g., OpenVINO, Geti), package managers (e.g., Helm), container managers (e.g. Docker), orchestration frameworks (e.g., Kubernetes), and so forth.

In the test phase 505, the applications are tested on multiple compute platforms/architectures 506 with varying resources and resource capacities (e.g., number of cores, frequency/speed, cache size, memory size) and under varying configurations. For example, applications may be tested on different types, makes, and/or models of XPUs, such as central processing units (CPUs), graphics processing units (GPUs), vision processing unit (VPUs), field-programmable gate arrays (FPGAs), and/or other application-specific integrated circuits (ASICs)). As an example, during the test phase 505, it may be determined that an application performs better or worse on certain compute platforms (e.g., latency or throughput increases by X amount on CPU A compared to CPU B and/or GPU A) and/or under different configurations (e.g., latency or throughput increases by X amount in configuration A compared to configuration B).

In the optimize phase 507, the applications are optimized based on the results of the test phase 505. For example, various optimizations 508 may be performed to optimize machine learning operations (ML Ops), lifecycle management, application performance, resource telemetry, video pipelines, and so forth.

The resulting application catalog can then be deployed on the appropriate compute devices in a computing infrastructure (e.g., edge or cloud infrastructure) based on various considerations, including workload requirements, service level agreements, resource availability, etc.

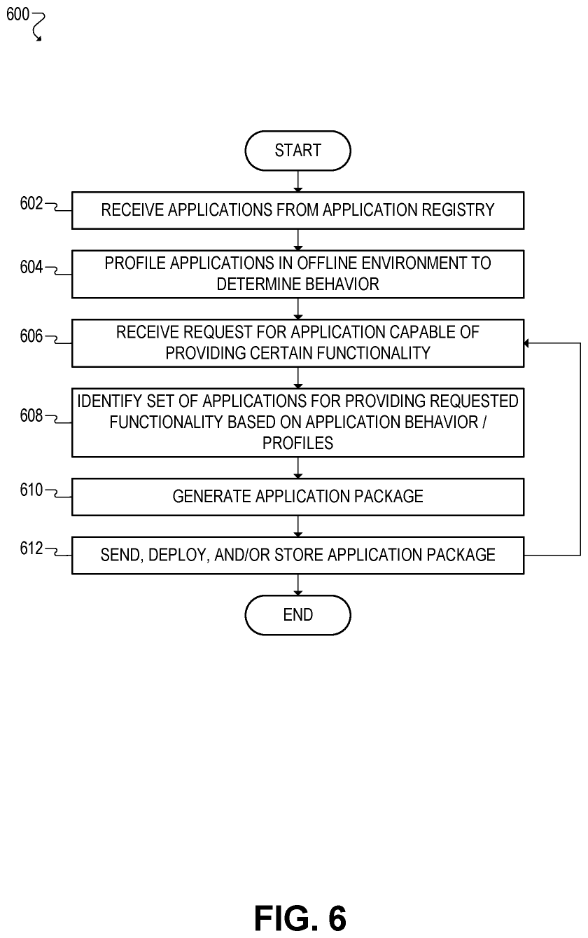

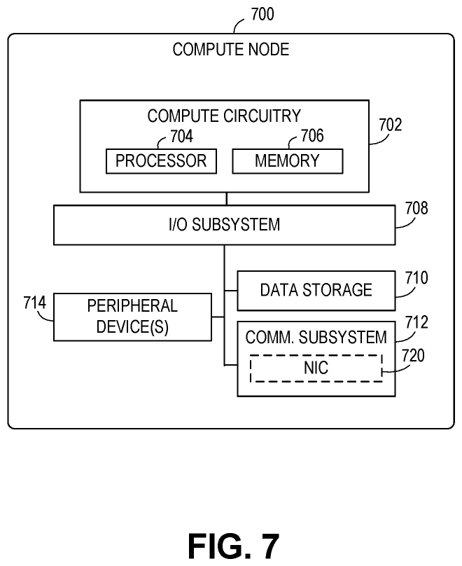

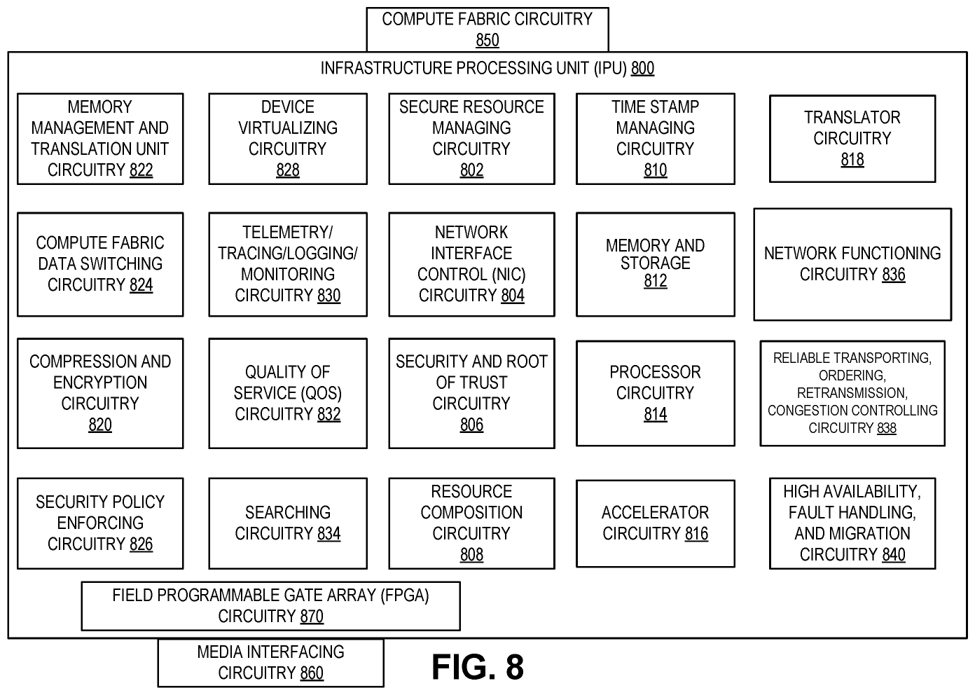

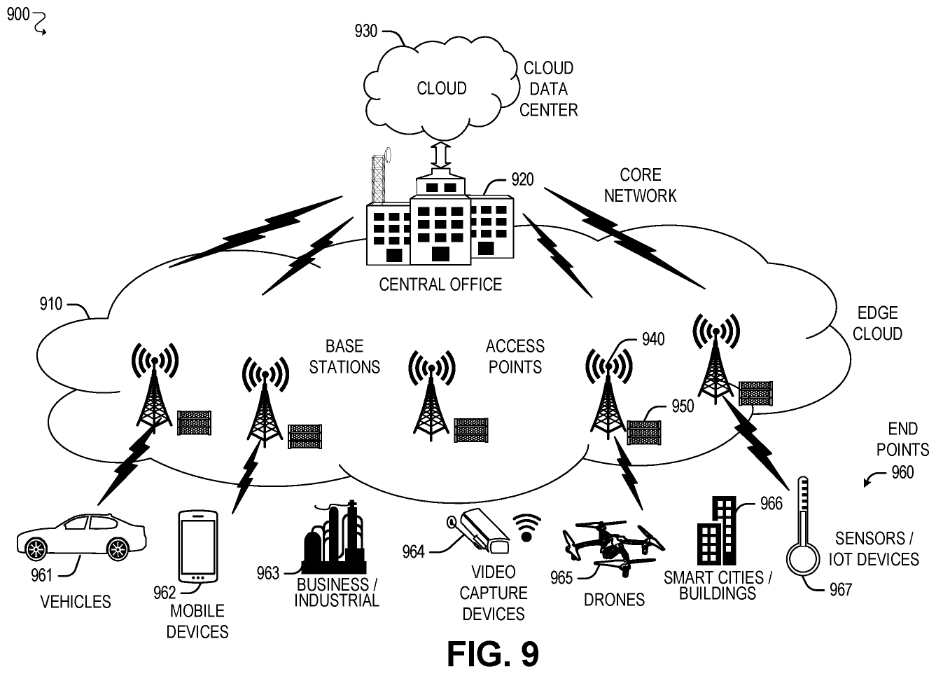

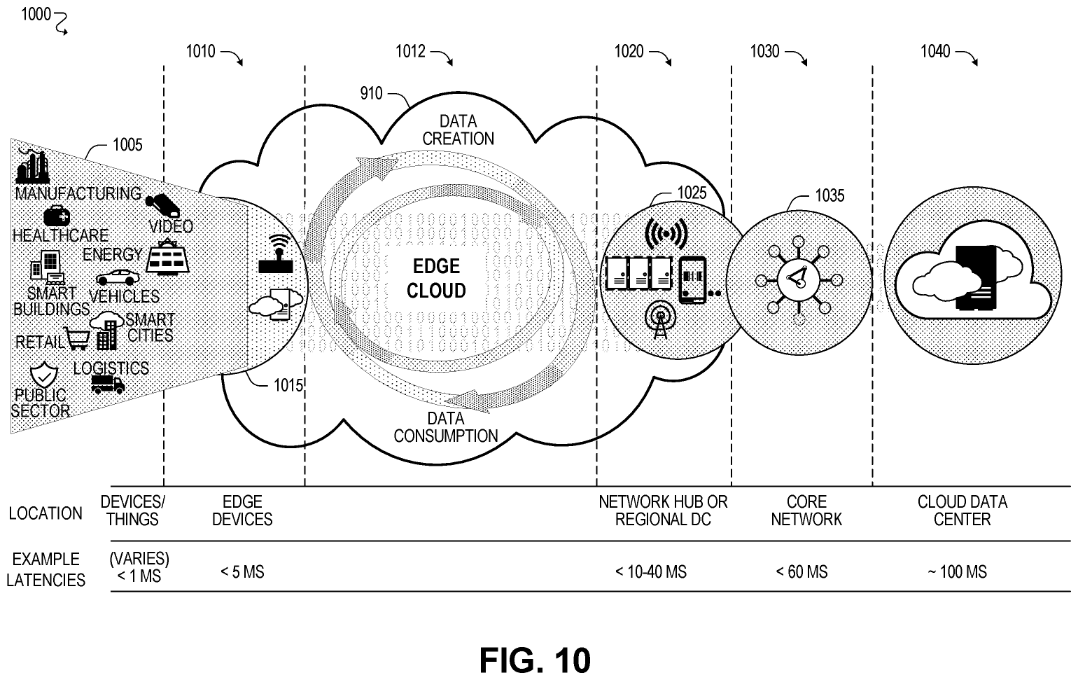

FIG. 6 illustrates a flowchart 600 for generating application packages based on offline workload profiling in accordance with certain embodiments. In some embodiments, flowchart 600 may be performed using the example computing devices and systems described throughout this disclosure (e.g., systems 100, 200, 300 of FIGS. 1-3, compute devices 700, 800 of FIGS. 7-8, edge/cloud environments of FIGS. 9-10), such as a device and/or system with interface circuitry/communication circuitry and processing circuitry.

In the illustrated embodiment, flowchart 600 may be performed to profile applications stored in a registry (e.g., to determine application behavior) and then generate application packages for requested types of functionality/services based on the profiling.

The flowchart begins at block 602 by receiving a plurality of applications from an application registry (e.g., over a network and/or via interface circuitry). In some embodiments, for example, the applications may be requested from the registry in order to perform the profiling.

The flowchart then proceeds to block 604 to profile the applications in an offline environment to determine the behavior of the applications during execution. For example, the applications may be executed in an offline environment using test data as input and under multiple configurations (e.g., to learn how the applications behave, tailor the behavior of the applications, improve performance, etc.)

In particular, one or more behavioral characteristics associated with the applications may be monitored during execution and/or obtained from the application data, including, without limitation, resource utilization (e.g., processor/XPU utilization such as utilization of CPUs, GPUs, FPGAs, ASICs, memory utilization, network utilization, disk utilization, etc.), power consumption, thermal characteristics, performance metrics, application dependencies, interactions among applications (e.g., inter-application interactions), deployment scenarios and use cases, I/O patterns, etc.

Further, certain configuration parameters for the applications may be tuned based on the profiling. For example, based on the monitored behavioral characteristics, one or more configuration parameters for a particular application may be adjusted (e.g., to learn how the application behaves, tailor the application behavior, improve performance, etc.) and the application may be restarted to continue monitoring the application under the updated configuration. The profiling may repeat in this manner to continue learning about application behavior, customizing application behavior, and/or optimizing application performance for the respective applications in different scenarios (e.g., on different types of compute hardware, different deployment scenarios and configurations, etc.).

In some embodiments, the profiling may be performed on compute devices that are idle or otherwise have available resource capacity for profiling the applications (e.g., processing capacity, memory capacity, etc.). For example, in a computing infrastructure with multiple compute devices (e.g., a cloud or edge infrastructure), some compute devices may be idle (e.g., no active workloads) or otherwise may not be fully utilized at any given time. Thus, the profiling may be performed opportunistically on those compute devices as they become available.

For example, compute devices with available processing capacity may be identified as they become idle or underutilized, and some or all of those compute devices may be selected to perform the profiling. Further, as the availability of the respective compute devices changes, the profiling may be migrated to other compute devices in the infrastructure that have become available.

The flowchart then proceeds to block 606, where a request or query is received (e.g., over a network and/or via interface circuitry) for an application capable of providing certain functionality. For example, the request may seek an application capable of performing, providing, or implementing a particular function or service. In some embodiments, the function or service may be an end-to-end service (e.g., private 5G network, intrusion detection system, etc.), which may be implemented by multiple applications that are chained together to perform different tasks associated with the end-to-end service.

Further, in some embodiments, the requested functionality may be specified in natural language format (e.g., human language) and interpreted using natural language processing (NLP) techniques.

The flowchart then proceeds to block 608 to identify a set of applications for providing the requested functionality based on the application behavior/profiles. For example, the set of applications may include various related applications that can be chained or packaged together to perform the requested functionality. Moreover, the set of related applications may be identified based on behavioral characteristics of the applications that were profiled, including, without limitation, application dependencies, interactions among applications, deployment scenarios and use cases, I/O patterns, resource utilization, power consumption, thermal characteristics, performance metrics, etc.

In some embodiments, for example, the set of applications may be identified using a neural network model trained to identify applications for varying types of functionality based on application behavior (e.g., by supplying the application behavior/behavioral characteristics as input to the neural network model).

The flowchart then proceeds to block 610 to generate an application package for performing the requested functionality. For example, the set of applications identified at block 608 may be configured to perform the requested functionality, and the configuration of the set of applications may be included in the application package.

In various embodiments, the applications themselves (e.g., code and/or executables) may or may not be included in the application package. In some cases, for example, the application package may include metadata identifying the specific applications, version numbers, and associated configurations for performing the requested functionality, thus enabling the applications to be retrieved from the registry or another appropriate source. Alternatively, the application package may include the applications and the associated configurations.

The flowchart then proceeds to block 612 to send, deploy, and/or store the application package (e.g., over a network and/or via interface circuitry). For example, the application package may be sent to the requestor, deployed on a computing infrastructure (e.g., infrastructure managed by the requestor), stored back in the application registry, etc.

At this point, the flowchart may be complete. In some embodiments, however, the flowchart may restart and/or certain blocks may be repeated. For example, in some embodiments, the flowchart may restart at block 602 and/or 606 to continue profiling applications stored in registries and/or receiving application requests.

### Example Embodiments

Examples of various computing devices, systems, and environments are presented below, which may be used to implement any or all aspects of the workload profiling solution described throughout this disclosure. In some embodiments, for example, the computing components of FIGS. 1, 2, 3 may be implemented using any or all of the components of computing devices/systems 700, 800 of FIGS. 7, 8. Further, the systems of FIGS. 1, 2, 3 may be implemented using the edge and/or cloud computing environments of FIGS. 9, 10.

### Computing Devices and Systems

Any of the compute nodes or devices discussed with reference to the present computing systems and environments may be fulfilled based on the components depicted in FIGS. 7, 8. Respective compute nodes may be embodied as a type of device, appliance, computer, server, or other “thing” capable of communicating with other edge, cloud, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions. As another example, a cloud compute device may be embodied as a server.

FIG. 7 illustrates an example of a compute node 700. In the illustrated example, the compute node 700 includes a compute engine (also referred to herein as “compute circuitry”) 702, an input/output (I/O) subsystem (also referred to herein as “I/O circuitry”) 708, data storage (also referred to herein as “data storage circuitry”) 710, a communication circuitry subsystem 712, and, optionally, one or more peripheral devices (also referred to herein as “peripheral device circuitry”) 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor (also referred to herein as “processor circuitry”) 704 and a memory (also referred to herein as “memory circuitry”) 706. The processor 704 may be embodied as any type of processor(s) capable of performing the functions described herein (e.g., executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, storage disks, or AI hardware (e.g., GPUs, programmed FPGAs, or ASICs tailored to implement an AI model such as a neural network). Such an xPU may be designed to receive, retrieve, and/or otherwise obtain programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that an xPU, an SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In some examples, all or a portion of the memory 706 may be integrated into the processor 704. The memory 706 may store various software and data used during operation such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices/disks 710 may be embodied as one or more of any type(s) of physical device(s) configured for short-term or long-term storage of data such as, for example, memory devices, memory, circuitry, memory cards, flash memory, hard disk drives (HDDs), solid-state drives (SSDs), and/or other data storage devices/disks. Individual data storage devices/disks 710 may include a system partition that stores data and firmware code for the data storage device/disk 710. Individual data storage devices/disks 710 may also include one or more operating system partitions that store data files and executables for operating systems depending on, for example, the type of compute node 700.

The communication circuitry 712 may be embodied as any communication circuit, device, or collection thereof, capable of enabling communications over a network between the compute circuitry 702 and another compute device (e.g., an edge gateway of an implementing edge computing system). The communication circuitry 712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., an edge gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied as a respective edge compute node (whether a client, gateway, or aggregation node) in an edge computing system or like forms of appliances, computers, subsystems, circuitry, or other components. Alternatively, the compute node 700 may be embodied as a respective cloud compute node in a cloud computing system (e.g., data center).

FIG. 8 depicts an example of an infrastructure processing unit (IPU). Different examples of IPUs disclosed herein enable improved performance, management, security and coordination functions between entities (e.g., cloud service providers), and enable infrastructure offload and/or communications coordination functions. As disclosed in further detail below, IPUs may be integrated with smart NICs and storage or memory (e.g., on a same die, system on chip (SoC), or connected dies) that are located at on-premises systems, base stations, gateways, neighborhood central offices, and so forth. Different examples of one or more IPUs disclosed herein can execute an application including any number of microservices, where each microservice runs in its own process and communicates using protocols (e.g., an HTTP resource API, message service or gRPC). Microservices can be independently deployed using centralized management of these services. A management system may be written in different programming languages and use different data storage technologies.

Furthermore, one or more IPUs can execute platform management, networking stack processing operations, security (crypto) operations, storage software, identity and key management, telemetry, logging, monitoring and service mesh (e.g., control how different microservices communicate with one another). The IPU can access an xPU to offload performance of various tasks. For instance, an IPU exposes XPU, storage, memory, and CPU resources and capabilities as a service that can be accessed by other microservices for function composition. This can improve performance and reduce data movement and latency. An IPU can perform capabilities such as those of a router, load balancer, firewall, TCP/reliable transport, a service mesh (e.g., proxy or API gateway), security, data-transformation, authentication, quality of service (QoS), security, telemetry measurement, event logging, initiating and managing data flows, data placement, or job scheduling of resources on an xPU, storage, memory, or CPU.

In the illustrated example of FIG. 8, the IPU 800 includes or otherwise accesses secure resource managing circuitry 802, network interface controller (NIC) circuitry 804, security and root of trust circuitry 806 , resource composition circuitry 808, time stamp managing circuitry 810, memory and storage 812, processing circuitry 814, accelerator circuitry 816, and/or translator circuitry 818. Any number and/or combination of other structure(s) can be used such as but not limited to compression and encryption circuitry 820, memory management and translation unit circuitry 822, compute fabric data switching circuitry 824, security policy enforcing circuitry 826, device virtualizing circuitry 828, telemetry, tracing, logging and monitoring circuitry 830, quality of service circuitry 832, searching circuitry 834, network functioning circuitry (e.g., routing, firewall, load balancing, network address translating (NAT), etc.) 836, reliable transporting, ordering, retransmission, congestion controlling circuitry 838, and high availability, fault handling and migration circuitry 840 shown in FIG. 8. Different examples can use one or more structures (components) of the example IPU 800 together or separately. For example, compression and encryption circuitry 820 can be used as a separate service or chained as part of a data flow with vSwitch and packet encryption.

In some examples, IPU 800 includes a field programmable gate array (FPGA) 870 structured to receive commands from an CPU, XPU, or application via an API and perform commands/tasks on behalf of the CPU, including workload management and offload or accelerator operations. The illustrated example of FIG. 8 may include any number of FPGAs configured and/or otherwise structured to perform any operations of any IPU described herein.

Example compute fabric circuitry 850 provides connectivity to a local host or device (e.g., server or device (e.g., xPU, memory, or storage device)). Connectivity with a local host or device or smartNIC or another IPU is, in some examples, provided using one or more of peripheral component interconnect express (PCIe), ARM AXI, Intel® QuickPath Interconnect (QPI), Intel® Ultra Path Interconnect (UPI), Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, XPU, and IPU (e.g., via CXL.cache and CXL.mem).

Example media interfacing circuitry 860 provides connectivity to a remote smartNIC or another IPU or service via a network medium or fabric. This can be provided over any type of network media (e.g., wired or wireless) and using any protocol (e.g., Ethernet, InfiniBand, Fiber channel, ATM, to name a few).

In some examples, instead of the server/CPU being the primary component managing IPU 800, IPU 800 is a root of a system (e.g., rack of servers or data center) and manages compute resources (e.g., CPU, xPU, storage, memory, other IPUs, and so forth) in the IPU 800 and outside of the IPU 800. Different operations of an IPU are described below.

In some examples, the IPU 800 performs orchestration to decide which hardware or software is to execute a workload based on available resources (e.g., services and devices) and considers service level agreements and latencies, to determine whether resources (e.g., CPU, xPU, storage, memory, etc.) are to be allocated from the local host or from a remote host or pooled resource. In examples when the IPU 800 is selected to perform a workload, secure resource managing circuitry 802 offloads work to a CPU, xPU, or other device and the IPU 800 accelerates connectivity of distributed runtimes, reduce latency, CPU and increases reliability.

In some examples, secure resource managing circuitry 802 runs a service mesh to decide what resource is to execute workload, and provide for L7 (application layer) and remote procedure call (RPC) traffic to bypass kernel altogether so that a user space application can communicate directly with the example IPU 800 (e.g., IPU 800 and application can share a memory space). In some examples, a service mesh is a configurable, low-latency infrastructure layer designed to handle communication among application microservices using application programming interfaces (APIs) (e.g., over remote procedure calls (RPCs)). The example service mesh provides fast, reliable, and secure communication among containerized or virtualized application infrastructure services. The service mesh can provide critical capabilities including, but not limited to service discovery, load balancing, encryption, observability, traceability, authentication and authorization, and support for the circuit breaker pattern.

In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-oF, or CXL.

In some cases, the example IPU 800 dynamically selects itself to run a given workload (e.g., microservice) within a composable infrastructure including an IPU, xPU, CPU, storage, memory, and other devices in a node.

In some examples, communications transit through media interfacing circuitry 860 of the example IPU 800 through a NIC/smartNIC (for cross node communications) or loopback back to a local service on the same host. Communications through the example media interfacing circuitry 860 of the example IPU 800 to another IPU can then use shared memory support transport between xPUs switched through the local IPUs. Use of IPU-to-IPU communication can reduce latency and jitter through ingress scheduling of messages and work processing based on service level objective (SLO).

For example, for a request to a database application that requires a response, the example IPU 800 prioritizes its processing to minimize the stalling of the requesting application. In some examples, the IPU 800 schedules the prioritized message request issuing the event to execute a SQL query database and the example IPU constructs microservices that issue SQL queries and the queries are sent to the appropriate devices or services.

### Edge Computing

FIG. 9 is a block diagram 900 showing an overview of a configuration for edge computing, which includes a layer of processing referred to in many of the following examples as an “edge cloud”. As shown, the edge cloud 910 is co-located at an edge location, such as an access point or base station 940, a local processing hub 950, or a central office 920, and thus may include multiple entities, devices, and equipment instances. The edge cloud 910 is located much closer to the endpoint (consumer and producer) data sources 960 (e.g., autonomous vehicles 961, user equipment 962, business and industrial equipment 963, video capture devices 964, drones 965, smart cities and building devices 966, sensors and IoT devices 967, etc.) than the cloud data center 930. Compute, memory, and storage resources which are offered at the edges in the edge cloud 910 are critical to providing ultra-low latency response times for services and functions used by the endpoint data sources 960 as well as reduce network backhaul traffic from the edge cloud 910 toward cloud data center 930 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

FIG. 10 illustrates operational layers among endpoints, an edge cloud, and cloud computing environments. Specifically, FIG. 10 depicts examples of computational use cases 1005, utilizing the edge cloud 910 among multiple illustrative layers of network computing. The layers begin at an endpoint (devices and things) layer 1000, which accesses the edge cloud 910 to conduct data creation, analysis, and data consumption activities. The edge cloud 910 may span multiple network layers, such as an edge devices layer 1010 having gateways, on-premise servers, or network equipment (nodes 1015) located in physically proximate edge systems; a network access layer 1020, encompassing base stations, radio processing units, network hubs, regional data centers (DC), or local network equipment (equipment 1025); and any equipment, devices, or nodes located therebetween (in layer 1012, not illustrated in detail). The network communications within the edge cloud 910 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1000, under 5 ms at the edge devices layer 1010, to even between 10 to 40 ms when communicating with nodes at the network access layer 1020. Beyond the edge cloud 910 are core network 1030 and cloud data center 1040 layers, each with increasing latency (e.g., between 50-60 ms at the core network layer 1030, to 100 or more ms at the cloud data center layer). As a result, operations at a core network data center 1035 or a cloud data center 1045, with latencies of at least 50 to 100 ms or more, will not be able to accomplish many time-critical functions of the use cases 1005. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1035 or a cloud data center 1045, a central office or content data network may be considered as being located within a “near edge” layer (“near” to the cloud, having high latency values when communicating with the devices and endpoints of the use cases 1005), whereas an access point, base station, on-premise server, or network gateway may be considered as located within a “far edge” layer (“far” from the cloud, having low latency values when communicating with the devices and endpoints of the use cases 1005). It will be understood that other categorizations of a particular network layer as constituting a “close”, “local”, “near”, “middle”, or “far” edge may be based on latency, distance, number of network hops, or other measurable characteristics, as measured from a source in any of the network layers 1000-1040.

The various use cases 1005 may access resources under usage pressure from incoming streams, due to multiple services utilizing the edge cloud. To achieve results with low latency, the services executed within the edge cloud 910 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) perform remedial measures.

Thus, with these variations and service features in mind, edge computing within the edge cloud 910 may provide the ability to serve and respond to multiple applications of the use cases 1005 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 910 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 910 (network layers 1000-1040), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 910.

As such, the edge cloud 910 is formed from network components and functional features operated by and within edge gateway nodes, edge aggregation nodes, or other edge compute nodes among network layers 1010-1030. The edge cloud 910 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 910 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

The network components of the edge cloud 910 may be servers, multi-tenant servers, appliance computing devices, and/or any other type of computing devices. For example, the edge cloud 910 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIGS. 7, 8. The edge cloud 910 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

“Processing circuitry” may refer to any type and/or combination of circuitry for processing data. “Interface circuitry” or “communication circuitry” may refer to any type and/or combination of circuitry for communicating over an interface, including, without limitation, an input/output (I/O) interface and a network interface.

A non-transitory machine-readable medium (e.g., a computer-readable medium) may include any medium (e.g., storage device, storage disk, etc.) capable of storing, encoding or carrying instructions for execution by a machine and that cause the machine to perform any one or more of the methodologies of the present disclosure or that is capable of storing, encoding or carrying data structures utilized by or associated with such instructions. A “non-transitory machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks (e.g., SSDs); magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. As used herein, the term non-transitory computer readable medium is expressly defined to include any type of computer readable storage device and/or storage disk and to exclude propagating signals and to exclude transmission media. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e g , linked) if necessary, and compiled or interpreted (e.g., into a library, stand-alone executable, etc.) at a local machine, and executed by the local machine.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

### EXAMPLES

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes at least one non-transitory machine-readable storage medium having instructions stored thereon, wherein the instructions, when executed on processing circuitry, cause the processing circuitry to: receive, via interface circuitry, a plurality of applications from an application registry; determine, based on profiling the applications, behavior of the applications during execution; generate, based on the behavior of the applications, an application package for performing a particular function, wherein the application package comprises a configuration of a set of applications for performing the particular function, wherein the set of applications are identified from the plurality of applications; and store, via the interface circuitry, the application package in the application registry.

Example 2 includes the storage medium of Example 1, wherein the instructions that cause the processing circuitry to generate, based on the behavior of the applications, the application package for performing the particular function further cause the processing circuitry to: identify, based on the behavior of the applications, the set of applications for performing the particular function; and configure the set of applications to perform the particular function.

Example 3 includes the storage medium of Example 2, wherein the instructions that cause the processing circuitry to identify, based on the behavior of the applications, the set of applications for performing the particular function further cause the processing circuitry to: identify, based on a neural network model, the set of applications for performing the particular function, wherein the neural network model is trained to identify the set of applications based on the behavior of the plurality of applications, wherein the behavior of the plurality of applications is supplied as input to the neural network model.

Example 4 includes the storage medium of any of Examples 1-3, wherein the instructions further cause the processing circuitry to: receive, via the interface circuitry, a request for an application capable of performing the particular function; and send, via the interface circuitry and based on the request, the application package for performing the particular function.

Example 5 includes the storage medium of any of Examples 1-4, wherein the instructions that cause the processing circuitry to determine, based on profiling the applications, the behavior of the applications during execution further cause the processing circuitry to: identify, in a computing infrastructure, one or more compute devices with available processing capacity to profile the applications, wherein the computing infrastructure comprises a plurality of compute devices; and profile the applications on the one or more compute devices.

Example 6 includes the storage medium of Example 5, wherein the instructions that cause the processing circuitry to identify, in the computing infrastructure, the one or more compute devices with available processing capacity to profile the applications further cause the processing circuitry to: determine that the one or more compute devices are idle; and select the one or more compute devices to profile the applications.

Example 7 includes the storage medium of any of Examples 1-6, wherein the instructions that cause the processing circuitry to determine, based on profiling the applications, the behavior of the applications during execution further cause the processing circuitry to: execute the applications in an offline environment, wherein individual applications are executed based on a plurality of configurations using test data as input; and monitor one or more behavioral characteristics associated with the applications during execution.

Example 8 includes the storage medium of Example 7, wherein the one or more behavioral characteristics include one or more of resource utilization, power consumption, or thermal characteristics.

Example 9 includes the storage medium of any of Examples 7-8, wherein the one or more behavioral characteristics include interactions among the applications.

Example 10 includes the storage medium of any of Examples 7-9, wherein the instructions further cause the processing circuitry to: determine, based on the one or more behavioral characteristics, one or more configuration parameters to be adjusted for one or more of the applications; and adjust the one or more configuration parameters for one or more of the applications.

Example 11 includes the storage medium of any of Examples 1-10, wherein the particular function comprises an end-to-end service.

Example 12 includes a system, comprising: interface circuitry; and processing circuitry to: receive, via the interface circuitry, a plurality of applications from an application registry; determine, based on profiling the applications in an offline environment, behavior of the applications during execution; generate, based on the behavior of the applications, an application package for implementing a particular function, wherein the application package comprises a configuration of a set of applications for implementing the particular function, wherein the set of applications are identified from the plurality of applications; and store, via the interface circuitry, the application package in the application registry.

Example 13 includes the system of Example 12, wherein the processing circuitry to generate, based on the behavior of the applications, the application package for implementing the particular function is further to: identify, based on the behavior of the applications, the set of applications for implementing the particular function; and configure the set of applications to implement the particular function.

Example 14 includes the system of Example 13, wherein the processing circuitry to identify, based on the behavior of the applications, the set of applications for implementing the particular function is further to: identify, based on a neural network model, the set of applications for performing the particular function, wherein the neural network model is trained to identify the set of applications based on the behavior of the plurality of applications, wherein the behavior of the plurality of applications is supplied as input to the neural network model.

Example 15 includes the system of any of Examples 12-14, wherein the processing circuitry is further to: receive, via the interface circuitry, a request for an application capable of implementing the particular function; and send, via the interface circuitry and based on the request, the application package for implementing the particular function.

Example 16 includes the system of any of Examples 12-15, wherein the processing circuitry to determine, based on profiling the applications in the offline environment, the behavior of the applications during execution is further to: identify, in a computing infrastructure, one or more compute devices with available processing capacity to profile the applications, wherein the computing infrastructure comprises a plurality of compute devices; and profile the applications on the one or more compute devices.

Example 17 includes the system of Example 16, wherein the processing circuitry to identify, in the computing infrastructure, the one or more compute devices with available processing capacity to profile the applications is further to: determine that the one or more compute devices are idle; and select the one or more compute devices to profile the applications.

Example 18 includes the system of any of Examples 12-17, wherein the processing circuitry to determine, based on profiling the applications in the offline environment, the behavior of the applications during execution is further to: execute the applications in the offline environment, wherein individual applications are executed based on a plurality of configurations using test data as input; and monitor one or more behavioral characteristics associated with the applications during execution.

Example 19 includes the system of Example 18, wherein the one or more behavioral characteristics include one or more of resource utilization, power consumption, or thermal characteristics.

Example 20 includes the system of any of Examples 18-19, wherein the one or more behavioral characteristics include interactions among the applications.

Example 21 includes the system of any of Examples 18-20, wherein the processing circuitry is further to: determine, based on the one or more behavioral characteristics, one or more configuration parameters to be adjusted for one or more of the applications; and adjust the one or more configuration parameters for one or more of the applications.

Example 22 includes the system of any of Examples 12-21, wherein the particular function comprises an end-to-end service.

Example 23 includes a method, comprising: receiving, via interface circuitry, a plurality of applications from an application registry; determining, based on profiling the applications in an offline environment, behavior of the applications during execution; generating, based on the behavior of the applications, an application package for implementing a particular service, wherein the application package comprises a configuration of a set of applications for implementing the particular service, wherein the set of applications are identified from the plurality of applications; and storing, via the interface circuitry, the application package in the application registry.

Example 24 includes the method of Example 23, wherein generating, based on the behavior of the applications, the application package for implementing the particular service comprises: identifying, based on the behavior of the applications, the set of applications for implementing the particular service; and configuring the set of applications to implement the particular service.

Example 25 includes the method of Example 24, wherein identifying, based on the behavior of the applications, the set of applications for implementing the particular service comprises: identifying, based on a neural network model, the set of applications for implementing the particular service, wherein the neural network model is trained to identify the set of applications based on the behavior of the plurality of applications, wherein the behavior of the plurality of applications is supplied as input to the neural network model.

Example 26 includes the method of any of Examples 23-25, further comprising: receiving, via the interface circuitry, a request for an application capable of implementing the particular service; and sending, via the interface circuitry and based on the request, the application package for implementing the particular service.

Example 27 includes the method of any of Examples 23-26, wherein determining, based on profiling the applications in the offline environment, the behavior of the applications during execution comprises: identifying, in a computing infrastructure, one or more compute devices with available processing capacity to profile the applications, wherein the computing infrastructure comprises a plurality of compute devices; and profiling the applications on the one or more compute devices.

Example 28 includes the method of Example 27, wherein identifying, in the computing infrastructure, the one or more compute devices with available processing capacity to profile the applications comprises: determining that the one or more compute devices are idle; and selecting the one or more compute devices to profile the applications.

Example 29 includes the method of any of Examples 23-28, wherein determining, based on profiling the applications in the offline environment, the behavior of the applications during execution comprises: executing the applications in the offline environment, wherein individual applications are executed based on a plurality of configurations using test data as input; and monitoring one or more behavioral characteristics associated with the applications during execution.

Example 30 includes the method of Example 29, wherein the one or more behavioral characteristics include one or more of resource utilization, power consumption, or thermal characteristics.

Example 31 includes the method of any of Examples 29-30, wherein the one or more behavioral characteristics include interactions among the applications.

Example 32 includes the method of any of Examples 29-31, further comprising: determining, based on the one or more behavioral characteristics, one or more configuration parameters to be adjusted for one or more of the applications; and adjusting the one or more configuration parameters for one or more of the applications.

Example 33 includes the method of any of Examples 23-32, wherein the particular service comprises an end-to-end service.

1. At least one non-transitory machine-readable storage medium having instructions stored thereon, wherein the instructions, when executed on processing circuitry, cause the processing circuitry to:
receive, via interface circuitry, a plurality of applications from an application registry;
determine, based on profiling the applications, behavior of the applications during execution;
generate, based on the behavior of the applications, an application package for performing a particular function, wherein the application package comprises a configuration of a set of applications for performing the particular function, wherein the set of applications are identified from the plurality of applications; and
store, via the interface circuitry, the application package in the application registry.

2. The storage medium of claim 1, wherein the instructions that cause the processing circuitry to generate, based on the behavior of the applications, the application package for performing the particular function further cause the processing circuitry to:
identify, based on the behavior of the applications, the set of applications for performing the particular function; and
configure the set of applications to perform the particular function.

3. The storage medium of claim 2, wherein the instructions that cause the processing circuitry to identify, based on the behavior of the applications, the set of applications for performing the particular function further cause the processing circuitry to:
identify, based on a neural network model, the set of applications for performing the particular function, wherein the neural network model is trained to identify the set of applications based on the behavior of the plurality of applications, wherein the behavior of the plurality of applications is supplied as input to the neural network model.

4. The storage medium of claim 1, wherein the instructions further cause the processing circuitry to:
receive, via the interface circuitry, a request for an application capable of performing the particular function; and
send, via the interface circuitry and based on the request, the application package for performing the particular function.

5. The storage medium of claim 1, wherein the instructions that cause the processing circuitry to determine, based on profiling the applications, the behavior of the applications during execution further cause the processing circuitry to:
identify, in a computing infrastructure, one or more compute devices with available processing capacity to profile the applications, wherein the computing infrastructure comprises a plurality of compute devices; and
profile the applications on the one or more compute devices.

6. The storage medium of claim 5, wherein the instructions that cause the processing circuitry to identify, in the computing infrastructure, the one or more compute devices with available processing capacity to profile the applications further cause the processing circuitry to:
determine that the one or more compute devices are idle; and
select the one or more compute devices to profile the applications.

7. The storage medium of claim 1, wherein the instructions that cause the processing circuitry to determine, based on profiling the applications, the behavior of the applications during execution further cause the processing circuitry to:
execute the applications in an offline environment, wherein individual applications are executed based on a plurality of configurations using test data as input; and
monitor one or more behavioral characteristics associated with the applications during execution.

8. The storage medium of claim 7, wherein the one or more behavioral characteristics include one or more of resource utilization, power consumption, or thermal characteristics.

9. The storage medium of claim 7, wherein the one or more behavioral characteristics include interactions among the applications.

10. The storage medium of claim 7, wherein the instructions further cause the processing circuitry to:
determine, based on the one or more behavioral characteristics, one or more configuration parameters to be adjusted for one or more of the applications; and
adjust the one or more configuration parameters for one or more of the applications.

11. The storage medium of claim 1, wherein the particular function comprises an end-to-end service.

12. A system, comprising:
interface circuitry; and
processing circuitry to:
receive, via the interface circuitry, a plurality of applications from an application registry;
determine, based on profiling the applications in an offline environment, behavior of the applications during execution;
generate, based on the behavior of the applications, an application package for implementing a particular function, wherein the application package comprises a configuration of a set of applications for implementing the particular function, wherein the set of applications are identified from the plurality of applications; and
store, via the interface circuitry, the application package in the application registry.

13. The system of claim 12, wherein the processing circuitry to generate, based on the behavior of the applications, the application package for implementing the particular function is further to:
identify, based on the behavior of the applications, the set of applications for implementing the particular function; and
configure the set of applications to implement the particular function.

14. The system of claim 12, wherein the processing circuitry is further to:
receive, via the interface circuitry, a request for an application capable of implementing the particular function; and
send, via the interface circuitry and based on the request, the application package for implementing the particular function.

15. The system of claim 12, wherein the processing circuitry to determine, based on profiling the applications in the offline environment, the behavior of the applications during execution is further to:
identify, in a computing infrastructure, one or more compute devices with available processing capacity to profile the applications, wherein the computing infrastructure comprises a plurality of compute devices; and
profile the applications on the one or more compute devices.

16. The system of claim 12, wherein the processing circuitry to determine, based on profiling the applications in the offline environment, the behavior of the applications during execution is further to:
execute the applications in the offline environment, wherein individual applications are executed based on a plurality of configurations using test data as input; and
monitor one or more behavioral characteristics associated with the applications during execution.

17. The system of claim 16, wherein the one or more behavioral characteristics include one or more of resource utilization, power consumption, thermal characteristics, or interactions among the applications.

18. A method, comprising:
receiving, via interface circuitry, a plurality of applications from an application registry;
determining, based on profiling the applications in an offline environment, behavior of the applications during execution;
generating, based on the behavior of the applications, an application package for implementing a particular service, wherein the application package comprises a configuration of a set of applications for implementing the particular service, wherein the set of applications are identified from the plurality of applications; and
storing, via the interface circuitry, the application package in the application registry.

19. The method of claim 18, wherein generating, based on the behavior of the applications, the application package for implementing the particular service comprises:
identifying, based on a neural network model, the set of applications for implementing the particular service, wherein the neural network model is trained to identify the set of applications based on the behavior of the plurality of applications, wherein the behavior of the plurality of applications is supplied as input to the neural network model.

20. The method of claim 18, wherein determining, based on profiling the applications in the offline environment, the behavior of the applications during execution comprises:
executing the applications in the offline environment, wherein individual applications are executed based on a plurality of configurations using test data as input; and
monitoring one or more behavioral characteristics associated with the applications during execution.
